(19) United States
(12) Patent Application Publication
(10) Pub. No.: US 2018/0047027 A1
(43) Pub. Date: Feb. 15, 2018

(54) DEVICE, METHOD, AND NON-TRANSITORY COMPUTER-READABLE RECORDING MEDIUM

(71) Applicant: FUJITSU LIMITED, Kawasaki-shi (JP)

(72) Inventors: Tetsuharu Sakurai, Yokohama (JP); Shingo Suzuki, Kawasaki (JP)

(73) Assignee: FUJITSU LIMITED, Kawasaki-shi (JP)

(21) Appl. No.: 15/672,880

(22) Filed: Aug. 9, 2017

(30) Foreign Application Priority Data
Aug. 12, 2016 (JP) 2016-158518

(51) Int. Cl. G06Q 20/42; G06Q 20/38; G06Q 20/40; G06Q 20/08

(52) U.S. Cl. CPC G06Q 20/42; G06Q 20/085; G06Q 20/389; G06Q 20/40; G06F 15/7839

(57) ABSTRACT

A device includes, a memory configured to store a limit value, a first unit value, a first remaining period, and a first usage value, and a processor coupled to the memory and the processor configured, to determine a first multiplication value of the first unit value and the first remaining period, to determine a first addition value of the first multiplication value and the first usage value, to perform a first comparison of the first addition value and the limit value, to perform a determination of whether it is necessary to output a first alert based on the first comparison, the first alert being with respect to the usage of the one or more services, and to output the first alert to a terminal when the determination indicates that it is necessary to output the first alert.

### CROSS-REFERENCE TO RELATED APPLICATION

This application is based upon and claims the benefit of priority of the prior Japanese Patent Application No. 2016-158518, filed on Aug. 12, 2016, the entire contents of which are incorporated herein by reference.

### FIELD

The embodiments discussed herein are related to technology of managing use of a service.

### BACKGROUND

A user who uses a virtual machine, a virtual disk, an application, or the like that is provided by a cloud service pays a usage fee to a service provider in accordance with a usage amount. In order to avoid too much increase in a usage amount, not only a user himself or herself pays attention but also a system that manages a usage amount or a usage fee is provided in a cloud system.

When an amount of resources actually allocated to a user has exceeded the predetermined amount, such a system may perform a prescribed action (for example, transmission of an e-mail).

Furthermore, such a system may send a notification to a user who uses a service based on a result of monitoring of service consumption, a consumption rate, a service activity level, or the like.

### SUMMARY

According to an aspect of the invention, A device includes, a memory configured to store a limit value, a first unit value, a first remaining period, and a first usage value, the limit value indicating an upper limit of usage of one or more services through a period, excess usage of the one or more services over the upper limit being restricted in the period, the first unit value relating to maximum possible usage per unit time, the first usage value indicating an amount of the one or more services which have been used between a beginning of the period and a first time point in the period, the first remaining period indicating duration between the first time point and an end of the period, and a processor coupled to the memory. And the processor is configured, to determine a first multiplication value of the first unit value and the first remaining period, to determine a first addition value of the first multiplication value and the first usage value, to perform a first comparison of the first addition value and the limit value, to perform a determination of whether it is necessary to output a first alert based on the first comparison, the first alert being with respect to the usage of the one or more services, and to output the first alert to a terminal when the determination indicates that it is necessary to output the first alert.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an outline of a system according to a present embodiment;

FIG. 2 is a functional block diagram of a physical server;

FIG. 3 is a functional block diagram of a management server;

FIG. 4 is a diagram illustrating an example of user data stored in a data storage unit;

FIG. 5 is a diagram illustrating an example of system data stored in the data storage unit;

FIG. 6 is a diagram illustrating an example of server data stored in the data storage unit;

FIG. 7 is a diagram illustrating an example of storage data stored in the data storage unit;

FIG. 8 is a diagram illustrating an example of event data stored in the data storage unit;

FIG. 9 is a diagram illustrating an example of first fee data stored in the data storage unit;

FIG. 10 is a diagram illustrating an example of upper limit value data stored in the data storage unit;

FIG. 11 is a diagram illustrating an example of unit price data stored in the data storage unit;

FIG. 12 is a diagram illustrating a processing flow of processing performed by a management server according to a first embodiment;

FIG. 13 is a diagram illustrating a processing flow of calculation processing according to the first embodiment;

FIG. 14 is a diagram illustrating an example of second fee data stored in the data storage unit;

FIG. 15 is a diagram illustrating an example of third fee data stored in the data storage unit;

FIG. 16 is a diagram illustrating a processing flow of processing performed by the management server according to the first embodiment;

FIGS. 17A and 17B are diagrams for explaining a notification timing of an alert;

FIGS. 18A and 18B are diagrams for explaining a notification timing of an alert;

FIG. 19 is a diagram illustrating a processing flow of processing performed by a management server according to a second embodiment;

FIG. 20 is a diagram illustrating a processing flow of calculation processing according to a third embodiment;

FIG. 21 is a diagram illustrating a processing flow of processing according to a fourth embodiment; and

FIG. 22 is a functional block diagram of a computer.

### DESCRIPTION OF EMBODIMENTS

Under conventional technology, a threshold for notification of an alert to a user is set in advance. For this reason, when setting of a threshold is not appropriate, notification of an alert is not performed, disabling suppression of an operation that causes an increase in a usage fee (for example, an excessive usage of a service, addition of a service, or the like).

According to an aspect, an embodiment discloses a method of suppressing an operation that causes an increase in a usage fee of a service.

### First Embodiment

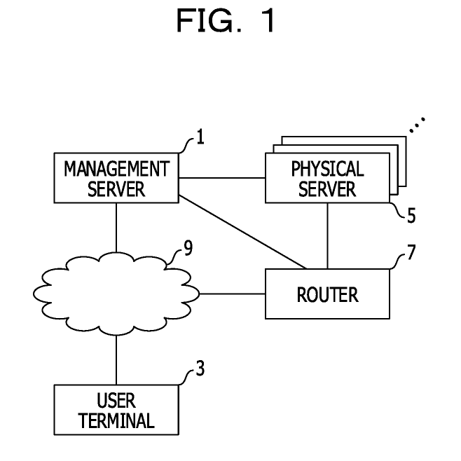

FIG. 1 illustrates an outline of a system according to the present embodiment. A management server 1 that performs main processing of the present embodiment is connected to a network 9 being the Internet, for example. The management server 1 manages a cloud service provided by a plurality of physical servers 5. Furthermore, the management server 1 performs setting of an access limitation from a user terminal 3 to a router 7, for example. The user terminal 3 being a terminal of a user of the service is connected to a network 9 and performs communication with the plurality of physical servers 5 via the router 7 to use the service. Furthermore, the user terminal 3 performs communication for authentication, communication for registration of a used service, or the like with the management server 1.

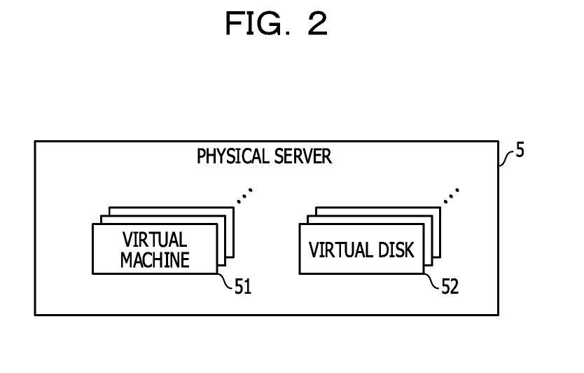

FIG. 2 illustrates a functional block diagram of the physical servers 5. The physical servers 5 executes one or a plurality of virtual machines 51 and one or a plurality of virtual disks 52 and uses the one or the plurality of virtual machines 51 and the one or the plurality of virtual disks 52 to execute an application program.

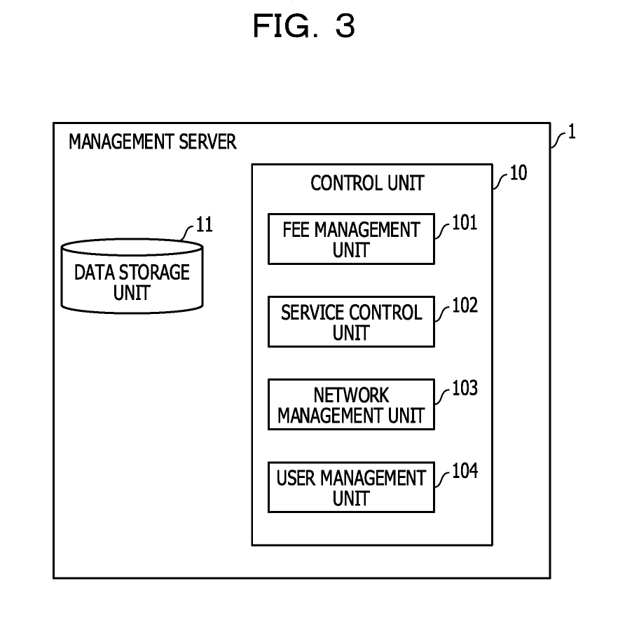

FIG. 3 illustrates a functional block diagram of the management server 1. The management server 1 includes a control unit 10 and a data storage unit 11. The control unit 10 includes a fee management unit 101, a service control unit 102, a network management unit 103, and a user management unit 104.

The fee management unit 101 manages a usage fee of the cloud service for each user. The service control unit 102 performs management of the cloud service provided by the plurality of physical servers 5. The network management unit 103 performs management of a band or the like in a network used by the plurality of physical servers 5 for communication. The user management unit 104 manages information on a user of the cloud service.

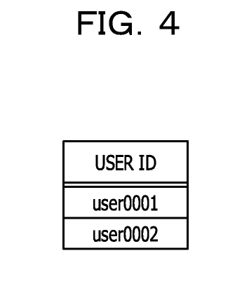

With reference to FIGS. 4 to 11, data stored in the data storage unit 11 will be described. It is to be noted that a format of the data is not limited to formats illustrated in FIGS. 4 to 11, and other formants (for example, a format with a pointer used) may be used.

FIG. 4 illustrates an example of user data stored in the data storage unit 11. In the example in FIG. 4, a user identifier (ID) being an ID of the user of the cloud service is stored.

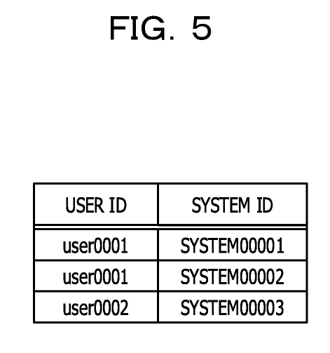

FIG. 5 illustrates an example of system data stored in the data storage unit 11. In the example in FIG. 5, a user ID and a system ID being a system ID for the cloud service used by the user are stored.

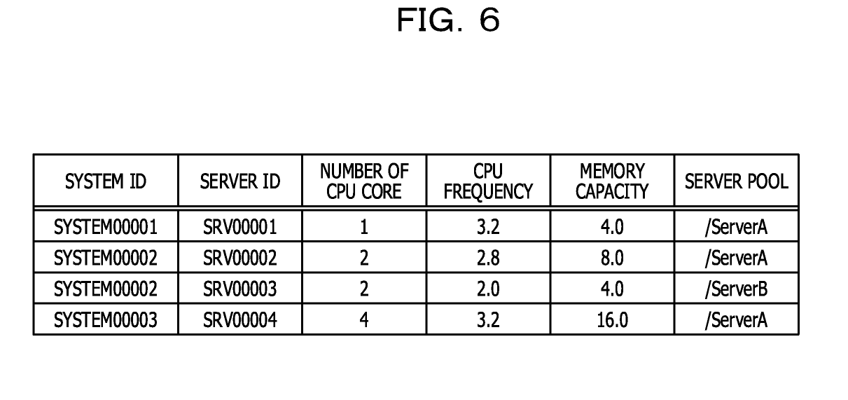

FIG. 6 illustrates an example of server data stored in the data storage unit 11. In the example in FIG. 6, a system ID, a server ID being an ID of a server included in the system (for example, a virtual machine), a number of central processing unit (CPU) cores used by the server included in the system, information on a frequency and a memory capacity of the CPU, and information on a server pool (for example, the physical servers 5) to which the server belongs are stored.

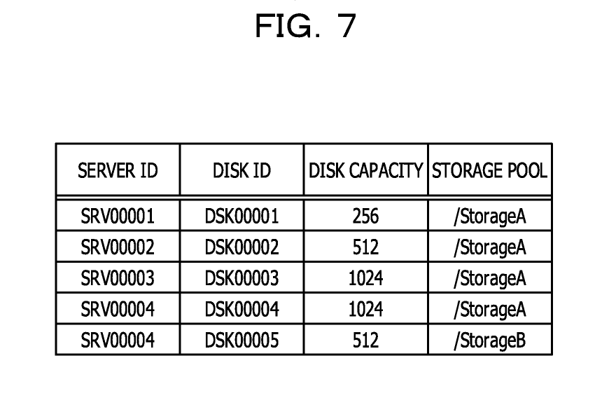

FIG. 7 illustrates an example of storage data stored in the data storage unit 11. In the example in FIG. 7, a server ID, a disk ID being an ID of a disk (for example, a virtual disk) used by the server, information on a capacity of the disk, and information on a storage pool (for example, a hard disk drive (HDD), a solid state drive (SSD), or the like) to which the disk belongs are stored.

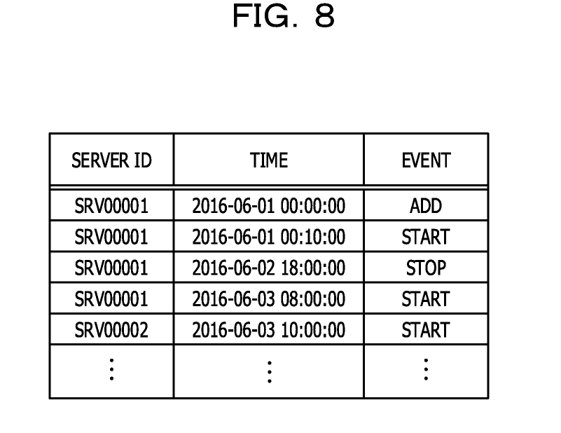

FIG. 8 illustrates an example of event data stored in the data storage unit 11. In the example in FIG. 8, a server ID, information on a time when an event has occurred, and information on the event that has occurred are stored. An event is addition, activation, stoppage, or the like of a virtual machine.

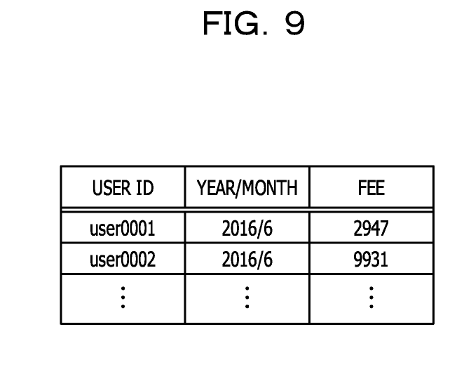

FIG. 9 illustrates an example of first fee data stored in the data storage unit 11. In the example in FIG. 9, a user ID, information on a year and a month, and information on a fee actually generated after start of a payment cycle before a current time point are stored. The payment cycle is a period that is to be a target for calculation of a fee for one time, for example, one month. The actually generated fee is calculated based on server data, storage data, unit price data, event data, and the like.

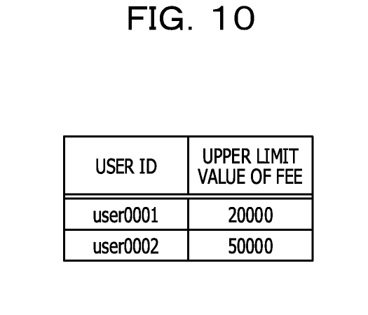

FIG. 10 illustrates an example of upper limit value data stored in the data storage unit 11. In the example in FIG. 10, a user ID and an upper limit value of the fee are stored. An upper limit value of the fee is set in advance by a manager of the cloud service or a manager of the system used by the user. When the fee exceeds the upper limit value, the upper limit value is raised or a usage of the service is stopped.

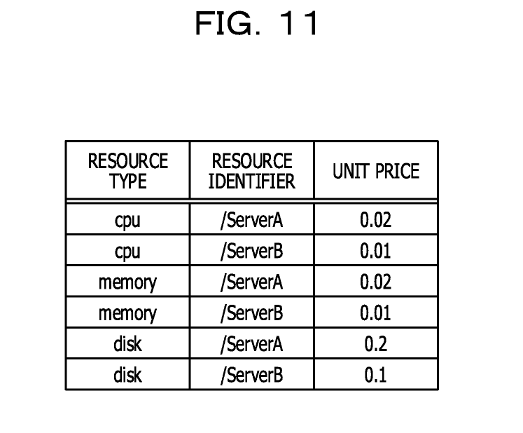

FIG. 11 illustrates an example of the unit price data stored in the data storage unit 11. In the example in FIG. 11, information on a type of a resource, a resource identifier (in this case, information on a server pool and the information on a storage pool), and information on a unit price in a case where the resource is used in a unit time (for example, one hour) are stored.

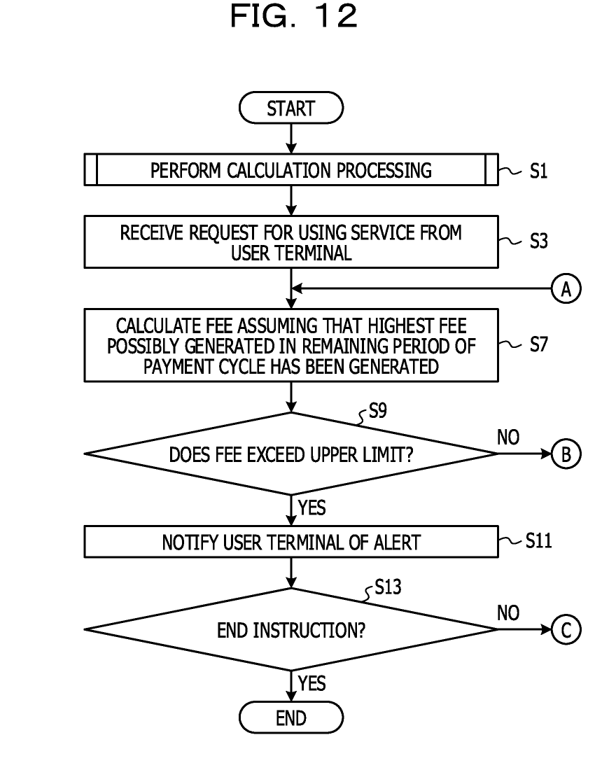

Next, with reference to FIGS. 12 to 18B, processing performed by the management server 1 according to the first embodiment will be described.

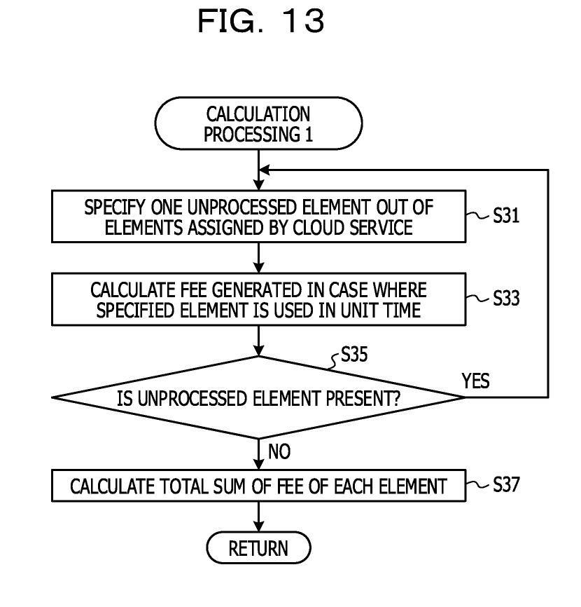

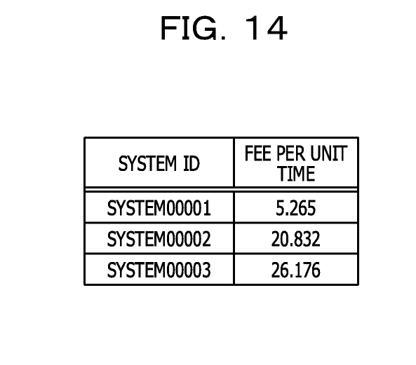

Firstly, a fee management unit 101 of the management server 1 performs calculation processing (step S1 in FIG. 12). The calculation processing will be described with reference to FIGS. 13 and 14. It is to be noted that when the cloud system provides a plurality of cloud services, the calculation processing is performed with respect to each of the plurality of cloud services. However, for ease of explanation, processing performed with respect to one cloud service is described as an example.

The fee management unit 101 specifies one unprocessed element out of elements assigned to the user by the cloud service (for example, a virtual machine, a virtual disk, an application, or the like) (step S31 in FIG. 13). At step S31, the unprocessed element is specified in a unit of one usage of the cloud service. For example, when two virtual machines are used in the cloud service, two virtual machines are specified as the unprocessed element.

The fee management unit 101 calculates, based on the unit price data (FIG. 11), a fee to be generated in a case where the element specified at step S31 is used in a unit time (step S33).

For example, it is assumed that one virtual machine in the cloud service, one virtual disk of 500 gigabytes (GB), and communication of 32 megabits per second (Mbps) are used, and the unit time is one hour. With respect to the unit prices, the one virtual machine is 10 (yen/hour), the one virtual disk of 500 GB is 0.01 (yen/(time·GB)), and hypertext transfer protocol (HTTP) communication is 15 (yen/GB). In this case, a fee per unit time with respect to the virtual machine is 10 (yen/time)*one (machine)=10 (yen/time). A fee per unit time with respect to the virtual disk is 0.01 (yen/(time·GB))*500 (GB)*one (machine)=5 (yen/time). A fee per unit time with respect to the HTTP communication is 15 (yen/GB)*(32 (Mbps)/(8*1000))*3600 (seconds)=216 (yen/time). It is to be noted that a fee for using in a unit time is a fee in a case where a unit time element continues to be used and thus corresponds to the highest fee possibly generated per unit time.

The fee management unit 101 determines whether an unprocessed element is present (step S35). When an unprocessed element is present (Yes route at step S35), the processing returns to step S31. On the other hand, when an unprocessed element is not present (No route at step S35), the fee management unit 101 calculates a total sum of a fee of each element (step S37). Furthermore, the fee management unit 101 causes the data storage unit 11 to store therein the calculated total sum and the user ID of the user using the cloud service in an associated manner as second fee data. The processing then returns to a caller.

FIG. 14 illustrates an example of the second fee data stored in the data storage unit 11. In the example in FIG. 14, a system ID and a fee per unit time are stored. In this case, one system corresponds to one cloud service. In the case of the example described at step S33, 10+5+216=231 (yen/time) is calculated as a total sum and this total sum corresponds to a fee in a case where the cloud service is used in a unit time.

Now back to the description of FIG. 12, the user management unit 104 receives a request for using the cloud service from the user terminal 3 (step S3). The cloud service specified in the request for using is hereinafter referred to as a “target cloud service”. Furthermore, when the user operating the user terminal 3 has not been registered, the user management unit 104 adds data of the user to the user data (FIG. 4) and registers the user ID thereof and a system ID corresponding to a target cloud service in an associated manner as system data.

The fee management unit 101 assumes that the highest fee possibly generated in a remaining period of the payment cycle has been generated, and calculates a fee of the payment cycle (hereinafter, referred to as a maximum fee) with respect to the target cloud service (step S7). The fee management unit 101 then causes the data storage unit 11 to store therein the calculated fee and the user ID of the user using the target cloud service in an associated manner as third fee data. It is to be noted that the maximum fee is calculated by adding a fee registered in the first fee data (FIG. 9) to a fee obtained by multiplying a fee registered in the second fee data (FIG. 14) by the remaining period.

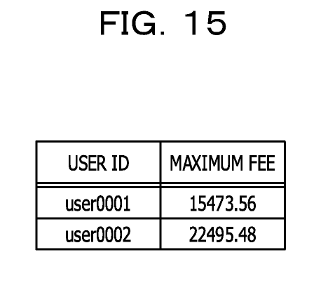

FIG. 15 illustrates an example of the third fee data stored in the data storage unit 11. In the example in FIG. 15, a user ID and a maximum value of a fee are stored. The maximum fee corresponds to a fee in a case where the target cloud service continues to be used in the remaining period of the payment cycle.

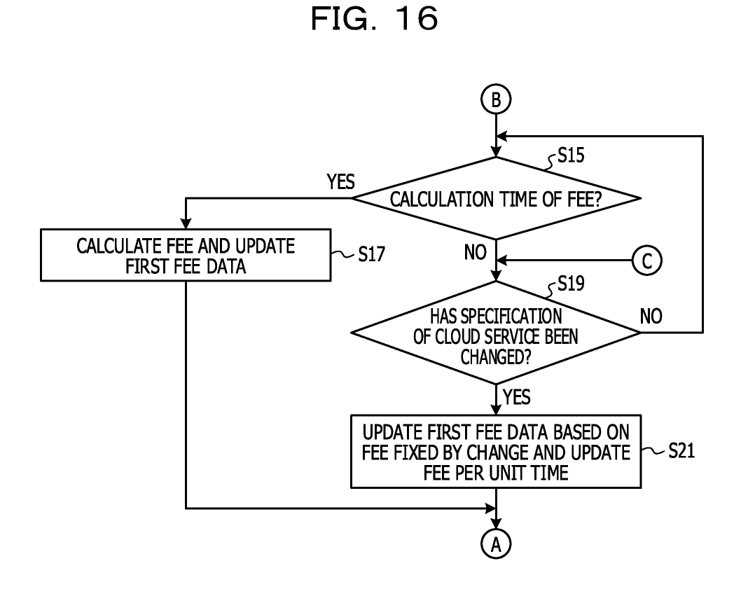

The fee management unit 101 determines whether the fee calculated at step S7 exceeds the upper limit value registered in the upper limit value data (FIG. 10) (step S9). When the fee calculated at step S7 does not exceed the upper limit value registered in the upper limit value data (FIG. 10) (No route at step S9), the processing proceeds to step S15 in FIG. 16 via a terminal B.

On the other hand, when the fee calculated at step S7 exceeds the upper limit value registered in the upper limit value data (FIG. 10) (Yes route at step S9), the service control unit 102 transmits, to the user terminal 3, an alert for notifying that the fee possibly exceeds the upper limit value (step S11).

The service control unit 102 determines whether an end instruction has been received from a manager of the cloud system (step S13). When an end instruction has not been received from the manager of the cloud system (No route at step S13), the processing proceeds to step S19 in FIG. 16 via a terminal C. On the other hand, when an end instruction has been received from the manager of the cloud system (Yes route at step S13), the processing is ended.

The processing after the terminal B will be described. Firstly, the fee management unit 101 determines whether a current time acquired from a system dock, for example, is a calculation time of the fee (step S15 in FIG. 16).

When the current time is a calculation time of the fee (Yes route at step S15), the fee management unit 101 calculates the fee to be paid by the user with respect to the target cloud service at the time point of processing at step S15 and updates the fee in the first fee data (step S17). The fee is calculated based on the server data, the storage data, the unit price data, the event data, and the like, for example. The processing then returns to step S7 in FIG. 12 via a terminal A.

On the other hand, when the current time is not a calculation time of the fee (No route at step S15), the fee management unit 101 determines whether a specification of the target cloud service has been changed (step S19). The specification of the target cloud service is changed by specification by the user or the manager of the cloud system, for example.

When the specification of the target cloud service has not been changed (No route at step S19), the processing returns to step S15. On the other hand, when the specification of the target cloud service has been changed (Yes route at step S19), the fee management unit 101 performs processing described below. Specifically, the fee management unit 101 updates the fee registered in the first fee data (FIG. 9) based on the fee fixed by the change. Furthermore, the fee management unit 101 calculates the highest fee possibly generated per unit time with respect to the cloud service after change and updates the second fee data (step S21). When the specification of the target cloud service has been changed, the fee to be paid is fixed with respect to the cloud service before the change in some cases, and the processing at step S21 thus is performed. The processing then returns to step S7 in FIG. 12 via the terminal A.

Performing processing as described above enables the user to recognize that the fee possibly exceeds the upper limit value at an early stage and to stop an operation that causes an increase in the fee (for example, an excessive usage of a service).

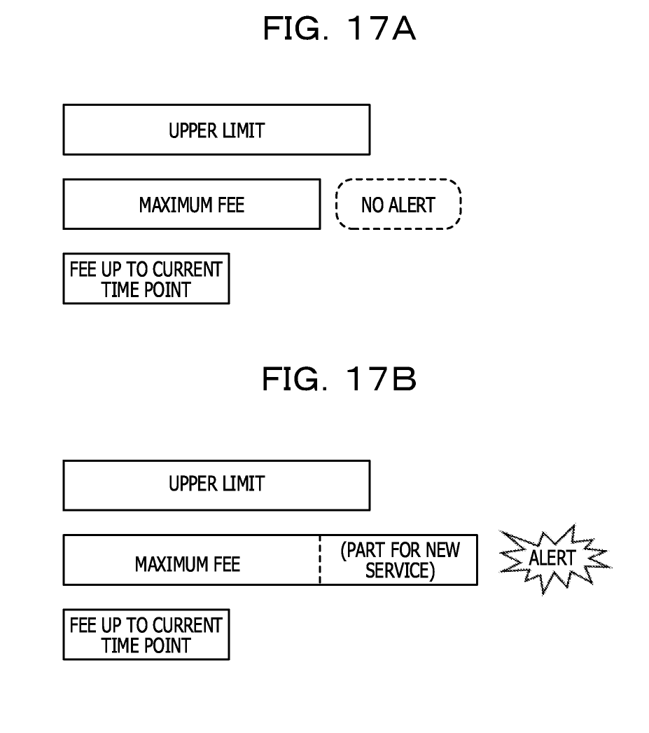

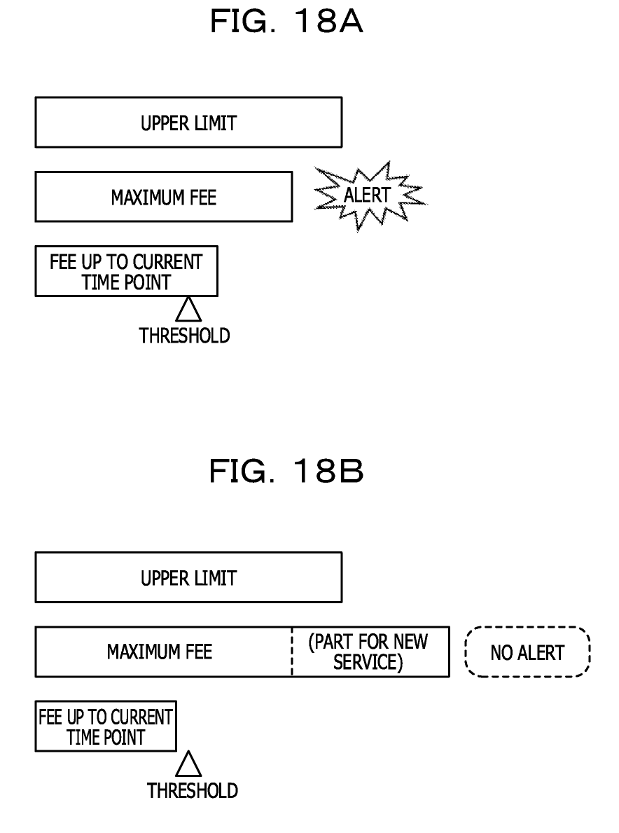

With reference to FIGS. 17A to 18B, a notification timing of an alert will be described. In the first embodiment, the maximum fee possibly generated is compared with the upper limit value and when the maximum fee exceeds the upper limit value, an alert is notified. With this, in an example as illustrated in FIG. 17A, an alert is not notified. By contrast, as illustrated in FIG. 17B, when the maximum fee has increased by a change in the specification of the cloud service (for example, addition of a virtual machine) to exceed the upper limit value, an alert is notified.

In a case where a configuration is employed in which a method as described in the first embodiment is not employed and the fee generated up to the current time point and a predetermined threshold are compared, as illustrated in FIG. 18A, even when the maximum fee has not reached the upper limit value, an alert may be notified. Furthermore, as illustrated in FIG. 18B, when the fee generated up to the current time point does not exceed the threshold, even when the maximum fee exceeds the upper limit value, an alert is not notified. With this, the user is not able to recognize that the fee possibly reaches the upper limit value. Furthermore, if a fixed threshold is set, when more resources are desired to be used after an alert is notified, for example, a notification timing of an alert is delayed in some cases.

By contrast, with the method in the present embodiment, when the fee does not possibly exceed the upper limit value, an alert is not notified. Furthermore, the user is able to grasp to what degree the fee will be when the cloud service is used to the maximum, whereby a guide for the user to raise the upper limit value becomes clear.

### Second Embodiment

According to the first embodiment, the user is able to recognize that the fee possibly reaches the upper limit value at an early stage. However, at an early stage of the payment cycle or before the actual fee exceeds a certain degree level, for example, there is a case where notification of an alert is not desired by the user. For this reason, in a second embodiment, processing as described below is performed.

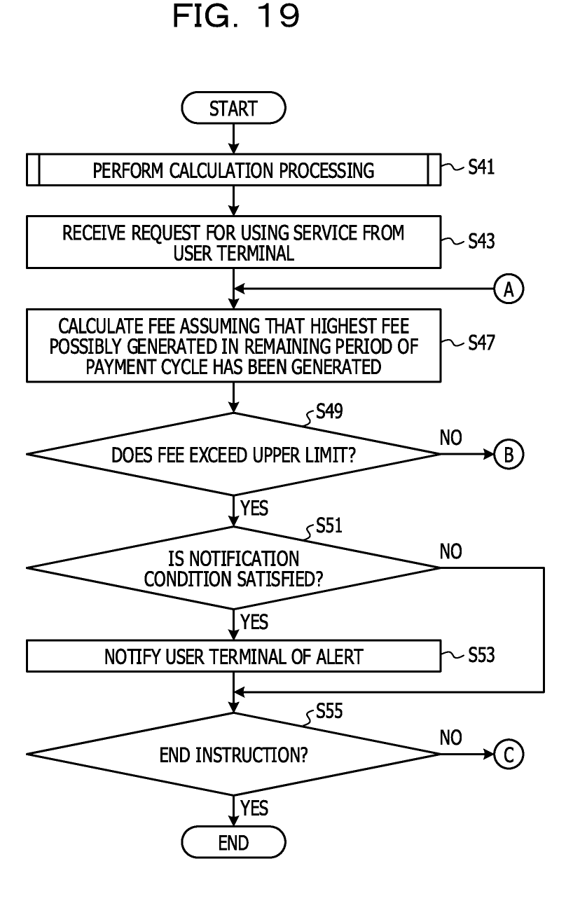

With reference to FIG. 19, processing performed by the management server 1 according to the second embodiment will be described. It is to be noted that when the cloud system provides a plurality of cloud services, the calculation processing is performed with respect to each of the plurality of cloud services. However, for ease of explanation, processing performed with respect to one cloud service is described as an example.

Firstly, the fee management unit 101 in the management server 1 performs calculation processing (step S41 in FIG. 19). The calculation processing is as described with reference to FIGS. 13 and 14, and the explanation thereof thus will be omitted.

The user management unit 104 receives a request for using a cloud service from the user terminal 3 (step S43). The cloud service specified in the request for using is hereinafter referred to as a “target cloud service”. Furthermore, when a user operating the user terminal 3 has not been registered, the user management unit 104 adds data of the user to the user data (FIG. 4) and registers a user ID thereof and a system ID corresponding to a target cloud service in an associated manner as system data.

The fee management unit 101 assumes that the highest fee possibly generated in the remaining period of the payment cycle has been generated, and calculates a fee of the payment cycle (hereinafter, referred to as a maximum fee) with respect to the target cloud service (step S47). The fee management unit 101 then causes the data storage unit 11 to store therein the calculated fee and the user ID of the user using the target cloud service in an associated manner as third fee data. It is to be noted that the maximum fee is calculated by adding a fee registered in the first fee data (FIG. 9) to a fee obtained by multiplying a fee registered in the second fee data (FIG. 14) by the remaining period.

The fee management unit 101 determines whether the fee calculated at step S47 exceeds the upper limit value registered in the upper limit value data (FIG. 10) (step S49). When the fee calculated at step S47 does not exceed the upper limit value registered in the upper limit value data (FIG. 10) (No route at step S49), the processing proceeds to step S15 in FIG. 16 via a terminal B.

On the other hand, when the fee calculated at step S47 exceeds the upper limit value registered in the upper limit value data (FIG. 10) (Yes route at step S49), the service control unit 102 performs processing described below. Specifically, the service control unit 102 determines whether a notification condition is satisfied (step S51). The notification condition is a condition that it is on or after a prescribed date in the payment cycle or a condition that the actual fee is higher than a prescribed amount, for example. However, the condition may be a condition other than these.

When the notification condition is not satisfied (No route at step S51), the processing proceeds to step S55. On the other hand, when the notification condition is satisfied (Yes route at step S51), the service control unit 102 transmits, to the user terminal 3, an alert for notifying that the fee possibly exceeds the upper limit value (step S53).

The service control unit 102 determines whether an end instruction has been received from a manager of the cloud system (step S55). When an end instruction has not been received from the manager of the cloud system (No route at step S55), the processing proceeds to step S19 in FIG. 16 via the terminal C. On the other hand, when an end instruction has been received from the manager of the cloud system (Yes route at step S55), the processing is ended.

Performing processing as described above enables to notify the user terminal 3 of an alert at a timing desirable for the user.

### Third Embodiment

In the first and the second embodiments, the maximum fee for the payment cycle is compared with the upper limit value. However, the fee to be compared may be a fee other than the maximum fee. For this reason, in a third embodiment, processing as described below is performed.

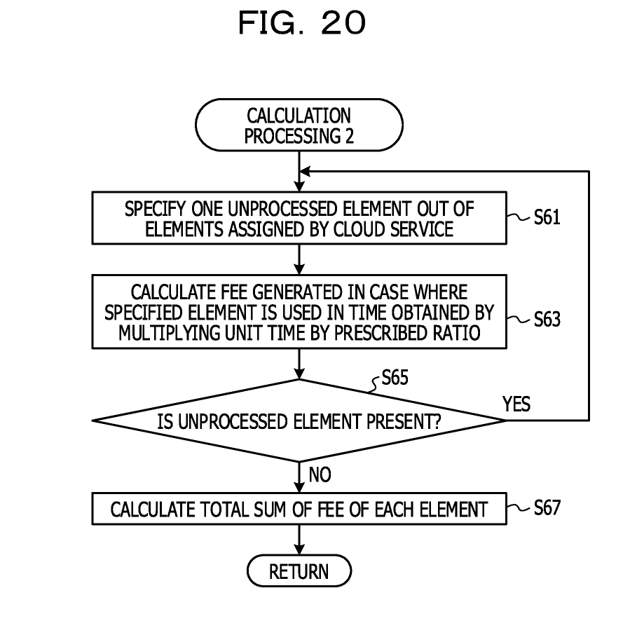

With reference to FIG. 20, calculation processing in the third embodiment will be described. Firstly, the fee management unit 101 specifies one unprocessed element out of elements assigned to the user by the cloud service (for example, a virtual machine, a virtual disk, an application, or the like) (step S61 in FIG. 20). At step S61, the unprocessed element is specified in a unit of one usage of the cloud service. For example, when two virtual machines are used in the cloud service, two virtual machines are specified as the unprocessed element.

The fee management unit 101 calculates, based on the unit price data (FIG. 11), a fee to be generated in a case where the element specified at step S61 is used in a time obtained by multiplying the unit time by a prescribed ratio (step S63). The prescribed ratio is 0.5, for example.

The fee management unit 101 determines whether an unprocessed element is present (step S65). When an unprocessed element is present (Yes route at step S65), the processing returns to step S61. On the other hand, when an unprocessed element is not present (No route at step S65), the fee management unit 101 calculates a total sum of a fee of each element (step S67). Furthermore, the fee management unit 101 causes the data storage unit 11 to store therein the calculated total sum and the user ID of the user using the cloud service in an associated manner as the second fee data. The processing then returns to a caller.

In the case of the third embodiment, at step S7 or step S47, the fee is calculated assuming that not the highest fee possibly generated but a fee obtained by multiplying the highest fee possibly generated by the prescribed ratio has been generated. With this, an alert is notified to the user at an earlier stage, enabling to suppress the fee from reaching the upper limit value.

### Fourth Embodiment

In the first and the second embodiments, it is assumed that the highest fee possibly generated in the remaining period of the payment cycle has been generated. In the third embodiment, it is assumed that a fee obtained by multiplying the highest fee possibly generated in the remaining period of the payment cycle by the prescribed ratio is generated. In a fourth embodiment described below, it is assumed that a fee is generated also in the remaining period of the payment cycle in the same manner as in the already elapsed period out of the payment cycle.

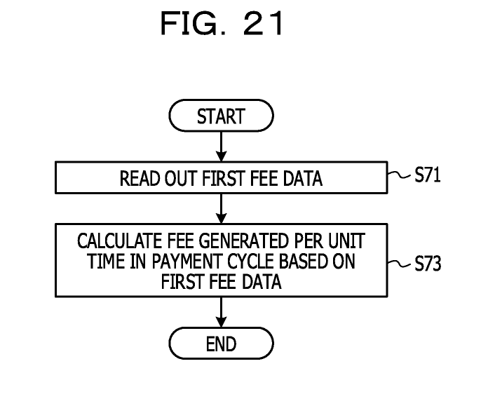

With reference to FIG. 21, processing performed at step S17 (FIG. 16) in the fourth embodiment will be described. Firstly, the fee management unit 101 reads out the first fee data (FIG. 9) (step S71 in FIG. 21).

The fee management unit 101 calculates, based on the read first fee data, a fee generated per unit time (for example, one hour) in the payment cycle (step S73). The fee management unit 101 then updates the fee in the second fee data (FIG. 14) with the calculated fee. The processing then returns to the processing in FIG. 16 to proceeds to step S7 in FIG. 12 via the terminal A.

Performing the processing as described above enables to perform notification of an alert based on an actual usage condition.

An embodiment of the present disclosure has been described above. However, the present disclosure is not limited to this. For example, the functional block configurations of the management server 1 and the physical servers 5 described above do not coincide with an actual program module configuration in some cases.

Furthermore, each data format described above is merely an example and does not have to have a configuration as described above. In the processing flows also, the orders of the pieces of the processing may be changed as long as processing results are unchanged. Furthermore, the pieces of the processing may be performed in parallel.

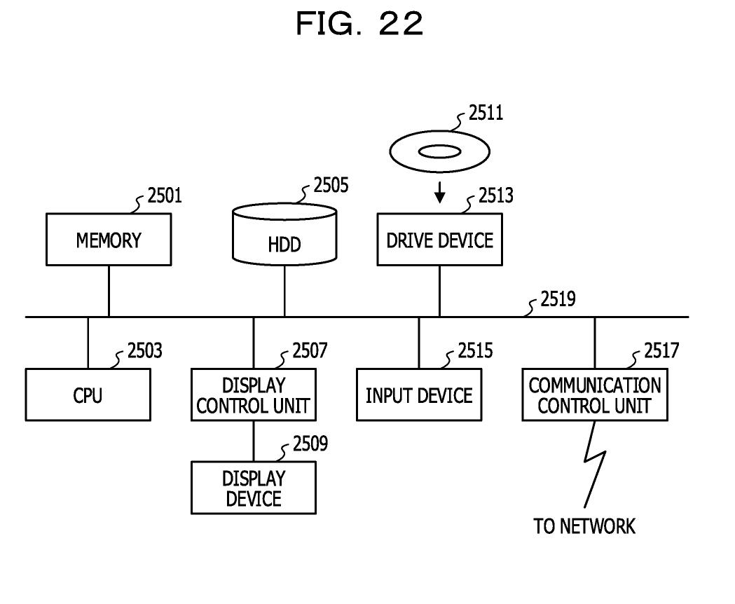

It is to be noted that the management server 1 described above is a computer device, in which, as illustrated in FIG. 22, a memory 2501, a central processing unit (CPU) 2503, a hard disk drive (HDD) 2505, a display control unit 2507 connected to a display device 2509, a drive device 2513 for a removable disk 2511, an input device 2515, and a communication control unit 2517 for connection to a network are connected to one another via a bus 2519. An operating system (OS) and an application program for performing the processing in the present embodiment are stored in the HDD 2505 and read out from the HDD 2505 to the memory 2501 when being executed by the CPU 2503. The CPU 2503 controls the display control unit 2507, the communication control unit 2517, and the drive device 2513 to perform a prescribed operation in accordance with details of processing of the application program. Furthermore, data in progress is stored mainly in the memory 2501, but may be configured to be stored in the HDD 2505. In an embodiment of the present disclosure, the application program for performing the above-described processing is stored in the removable disk 2511 which is computer-readable to be distributed and installed from the drive device 2513 to the HDD 2505. The application program is installed to the HDD 2505 via a network such as the Internet and the communication control unit 2517 in some cases. A computer device as described above implements various functions as described above with hardware such as the CPU 2503 and the memory 2501 and a program such as the OS and the application program, which are described above, working together organically.

An embodiment of the present disclosure described above is summarized as below.

An Information processing device (for example, the management server 1) according to a first aspect of the present embodiment includes (A) a storage unit (for example, a data storage unit 11) configured to store information on a first fee being a fee per unit time, information on a remaining period of a payment cycle, an upper limit value of the fee, and information on a fee at a current time point, and (B) a control unit (for example, the control unit 10) configured to multiply the first fee by the remaining period of the payment cycle based on the information stored in the storage unit and add the fee calculated by the multiplying to the fee at the current time point stored in the storage unit to calculate a maximum fee, and to determine whether notification of an alert is transmitted based on comparison between the maximum fee and the upper limit value stored in the storage unit.

Whether notification of an alert is transmitted is determined based on the maximum fee possibly generated, whereby a user is able to recognize that the fee possibly exceeds the upper limit value at an early stage and stop an operation that causes an increase in the fee (for example, an excessive usage of a service).

Furthermore, when the service is changed, the control unit may further (b1) update the information on the first fee with information on a second fee being a fee per unit time for a service after change, cause the storage unit to store the information on the second fee, multiply the second fee by the remaining period of the payment cycle based on the information stored in the storage unit, and add the fee calculated by the multiplying to the fee at the current time point stored in the storage unit to calculate a maximum fee, and determine whether notification of an alert is transmitted based on comparison between the maximum fee and the upper limit value stored in the storage unit. In a case where the service is changed in the middle of the payment cycle also, the user is able to know whether the fee possibly exceeds the upper limit value.

Furthermore, the control unit may further (b2) determine whether a first condition that the maximum fee is higher than the upper limit value and the current time point is on or after a prescribed point in the payment cycle is satisfied, and when the first condition is satisfied, transmit notification of an alert. This enables to transmit notification of an alert at a timing desirable for the user, as described above, because some users do not want notification of an alert to be transmitted at an early stage.

Furthermore, the control unit may further (b3) determine whether a second condition that the maximum fee is higher than the upper limit value and the fee at the current time point exceeds a prescribed threshold is satisfied, and when the second condition is satisfied, transmit notification of an alert. This enables to transmit notification of an alert at a timing desirable for the user, as described above, because some users do not want notification of an alert to be transmitted at an early stage.

Furthermore, the storage unit may further (a1) store therein information on a third fee obtained by multiplying the first fee by a prescribed ratio. The control unit may further (b4) multiply the third fee by the remaining period of the payment cycle based on the information stored in the storage unit and add the fee calculated by the multiplying to the fee at the current time point stored in the storage unit to calculate a fourth fee, and determine whether notification of an alert is transmitted based on comparison between the fourth fee and the upper limit value stored in the storage unit. With this, the user is able to know that the fee more possibly reaches the upper limit value.

Furthermore, the storage unit may further (a2) store therein information on a fifth fee generated per unit time in a period from a start time point of the payment cycle up to the current time point. The control unit may further (b5) multiply the fifth fee by the remaining period of the payment cycle based on the information stored in the storage unit and add the fee calculated by the multiplying to the fee at the current time point stored in the storage unit to calculate a sixth fee, and determine whether notification of an alert is transmitted based on comparison between the sixth fee and the upper limit value stored in the storage unit. This enables to transmit notification of an alert based on an actual usage condition.

An information processing method according to a second aspect of the present disclosure includes (c) multiplying a first fee by a remaining period of a payment cycle based on information stored in a storage unit that stores information on the first fee being a fee per unit time, information on the remaining period of the payment cycle, an upper limit value of the fee, and information on a fee at a current time point, (D) adding the fee calculated by the multiplying to the fee at the current time point stored in the storage unit to calculate a maximum fee, and (E) determining whether notification of an alert is transmitted based on comparison between the maximum fee and the upper limit value stored in the storage unit.

It is to be noted that a program for causing a computer to execute the processing using the above-described method is able to be created. The program is stored in a computer readable storage medium, such as a flexible disk, a CD-ROM, a magneto-optical disk, a semiconductor memory, a hard disk, or the like, or a storage device, for example. It is to be noted that an intermediate result of the processing is temporarily stored in the storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A device comprising:
a memory configured to store a limit value, a first unit value, a first remaining period, and a first usage value, the limit value indicating an upper limit of usage of one or more services through a period, excess usage of the one or more services over the upper limit being restricted in the period, the first unit value relating to maximum possible usage per unit time, the first usage value indicating an amount of the one or more services which have been used between a beginning of the period and a first time point in the period, the first remaining period indicating duration between the first time point and an end of the period; and
a processor coupled to the memory and the processor configured to:
determine a first multiplication value of the first unit value and the first remaining period,
determine a first addition value of the first multiplication value and the first usage value,
perform a first comparison of the first addition value and the limit value,
perform a determination of whether it is necessary to output a first alert based on the first comparison, the first alert being with respect to the usage of the one or more services, and
output the first alert to a terminal when the determination indicates that it is necessary to output the first alert.

2. The device according to claim 1, wherein the one or more services are provided by a virtual machine operated on one or more resources.

3. The device according to claim 2, wherein the first unit value is set for a first resource included in the one or more resources.

4. The device according to claim 1, wherein when another service is add to the one or more services, the first unit value is updated based on the other service.

5. The device according to claim 1, wherein the first unit value indicates a unit fee per unit time, the first usage value indicates a total fee charged between the beginning of the period and the first time point, and the period indicates a payment cycle.

6. The device according to claim 1, wherein the determination indicates that it is necessary to output the first alert when the first comparison indicates that the first addition value is no less than the limit value.

7. The device according to claim 6, wherein the first alert is output when the first time point is on or after a prescribed time point in the period.

8. The device according to claim 6, wherein the first alert is output when the first actual value is no less than a threshold level.

9. The device according to claim 1, wherein the determination indicates that it is not necessary to output the first alert when the first comparison indicates that the first addition value is less than the limit value.

10. The device according to claim 1, wherein the processor is configured to:
when another service is used instead of the one or more service at a second time point in the period, determine a second multiplication value of a second unit value and a second remaining period, the second unit value relating to maximum possible usage of the other service per unit time, the second remaining period indicating duration between the second time point and the end of the period,
determine a second addition value of the second multiplication value and a second usage value, the second usage value corresponding to an amount of the one or more services and the other service which have been used between the beginning of the period and the second time point in the period,
perform a second comparison of the second addition value and the limit value,
perform a second determination of whether it is necessary to output a second alert based on the second comparison, the second alert being with respect to the usage of the one or more services and the other service, and
output the second alert to the terminal when the second determination indicates that it is necessary to output the second alert.

11. The device according to claim 1, wherein the processor is configured to:
acquire a third unit value by multiplying the first unit value by a specific coefficient,
determine a third multiplication value of the third unit value and a first remaining period,
determine a third addition value of the third multiplication value and the first usage value,
perform a third comparison of the third addition value and the limit value, and
output a third alert with respect to the usage of the one or more services to the terminal device in accordance with a result of the third comparison.

12. The device according to claim 1, wherein the processor is configured to:
acquire a fourth unit value calculated based on both the first actual value and duration between the beginning of the period and the first time point,
determine a fourth multiplication value of the fourth unit value and the first remaining period,
determine a fourth addition value of the fourth multiplication value and the usage actual value,
perform a fourth comparison of the fourth addition value and the limit value, and
output a fourth alert with respect to a usage of the one or more services to the terminal device.

13. A method by a computer, the method comprising:
acquiring a limit value, a first unit value, a first remaining period, and a first usage value, the limit value indicating an upper limit of usage of one or more services through a period, excess usage of the one or more services over the upper limit being restricted in the period, the first unit value relating to maximum possible usage per unit time, the first usage value indicating an amount of the one or more services which have been used between a beginning of the period and a first time point in the period, the first remaining period indicating duration between the first time point and an end of the period;
determining a first multiplication value of the first unit value and the first remaining period;
determining a first addition value of the first multiplication value and the first usage value;
performing a first comparison of the first addition value and the limit value;
performing a determination of whether it is necessary to output a first alert based on the first comparison, the first alert being with respect to the usage of the one or more services; and
outputting the first alert to a terminal when the determination indicates that it is necessary to output the first alert.

14. A non-transitory computer-readable recording medium storing a program that causes a computer to execute an alert process comprising:
acquiring a limit value, a first unit value, a first remaining period, and a first usage value, the limit value indicating an upper limit of usage of one or more services through a period, excess usage of the one or more services over the upper limit being restricted in the period, the first unit value relating to maximum possible usage per unit time, the first usage value indicating an amount of the one or more services which have been used between a beginning of the period and a first time point in the period, the first remaining period indicating duration between the first time point and an end of the period;
determining a first multiplication value of the first unit value and the first remaining period;
determining a first addition value of the first multiplication value and the first usage value;
performing a first comparison of the first addition value and the limit value;
performing a determination of whether it is necessary to output a first alert based on the first comparison, the first alert being with respect to the usage of the one or more services; and
outputting the first alert to a terminal when the determination indicates that it is necessary to output the first alert.
